(19) United States
(12) Patent Application Publication
(10) Pub. No.: US 2022/0104453 A1
(43) Pub. Date: Apr. 7, 2022

(54) DOUBLE USE DISPOSABLE LITTER SYSTEM

(71) Applicant: PGC PRODUCTS, LLC, Oxford, NY (US)

(72) Inventors: KEITH C. DAY, GREENE, NY (US); ETHAN G. DAY, GREENE, NY (US); JOHN LEWIS, GREENE, NY (US)

(21) Appl. No.: 17/492,411

(22) Filed: Oct. 1, 2021

Related U.S. Application Data
(60) Provisional application No. 63/087,564, filed on Oct. 5, 2020.
(60) Provisional application No. 63/125,163, filed on Dec. 14, 2020.

(51) Int. Cl. A01K 1/01; B65B 1/02; B65B 1/04; B65B 5/04

(52) U.S. Cl. CPC A01K 1/0125; B65B 5/04; B65B 1/04; B65B 1/02

(57) ABSTRACT

A disposable litter system comprises a first litter box and a second litter box, each comprising opposing front and rear walls, opposing side walls, and a floor that is integral with the front, rear, and side walls. Each litter box is constructed from a single unitary piece of cardboard such that there are no seams between the front wall and each side wall of each litter box and there are no seams between the rear wall and each side wall of each litter box. The second litter box is sized such that the first litter box is nestable within the second litter box.

### CROSS-REFERENCE TO RELATED APPLICATIONS

This application claims priority to pending U.S. Provisional Application Ser. No. 63/087,564, filed Oct. 5, 2020, and U.S. Provisional Application Ser. No. 63/125,163, filed Dec. 14, 2020, the contents of which are incorporated herein by reference in their entirety.

### FIELD OF THE INVENTION

The present technology relates generally to animal waste receptacles and, specifically, to a disposable receptacle unit suitable for both shipment and litter use.

### BACKGROUND OF THE DISCLOSURE

The invention of litter for the capture of metabolic waste excretions from freely moving indoor pets corresponded to the need for adequate pans or box units to contain the litter. These litters, most commonly manufactured for use by cats, mimic the surfaces and materials found in nature which would normally attract the animal for this routine purpose. For the benefit of pet and cat owners, litters also offer a variety of other sanitary features to address odor control and efficient waste management. While the pan or box may be viewed as only the vessel for the litter, its role is important to the ongoing waste management process and becomes most noticeable when poorly designed or when adding more steps to the pet owner's already unpleasant task. Traditionally and widely available litter pans or boxes are constructed of hard plastic for long-term use. Users of these receptacles will inevitably discover the additional and frequent need to entirely empty the unit for washing, scrubbing, and drying: cat litters often fail to prevent penetration of liquids to the bottom of the unit, and cats are known to occasionally excrete wastes along the interior sides of the unit. Wastes left on the pan or box surface will, over time, lead to foul odors and unsanitary conditions, thus the additional cleaning task for pet owners.

### BRIEF SUMMARY OF THE DISCLOSURE

In one embodiment of the invention, a disposable litter system comprises a first litter box and a second litter box. The first litter box comprises opposing front and rear walls, opposing side walls, and a floor that is integral with the front, rear, and side walls to define a first chamber having an open top end. The second litter box comprises opposing front and rear walls, opposing side walls, and a floor integral with the front, rear, and side walls to define a second chamber having an open top end. The first litter box is constructed from a single unitary piece of cardboard such that there are no seams between the front wall and each side wall of the first litter box and there are no seams between the rear wall and each side wall of the first litter box. The second litter box is constructed from a single unitary piece of cardboard such that there are no seams between the front wall and each side wall of the second litter box and there are no seams between the rear wall and each side wall of the second litter box. The second litter box is sized such that the first litter box is nestable within the second litter box.

The system may further comprise a third litter box constructed from a single unitary piece of cardboard, the third litter box comprising opposing front and rear walls, opposing side walls, and a floor integral with the front, rear, and side walls to define a third chamber having an open top end. The third litter box is sized such that the second litter box is nestable within the third litter box.

The system may further comprise a fourth litter box constructed from a single unitary piece of cardboard, the fourth litter box comprising opposing front and rear walls, opposing side walls, and a floor integral with the front, rear, and side walls to define a fourth chamber having an open top end. The fourth litter box is sized such that the third litter box is nestable within the fourth litter box.

The rear wall of the first litter box may be taller than the front wall of the first litter box such that the side walls of the first litter box slope downward from the rear wall of the first litter box to the front wall of the first litter box. The rear wall of the second litter box may be taller than the front wall of the second litter box such that the side walls of the second litter box slope downward from the rear wall of the second litter box to the front wall of the second litter box.

A top edge of the front wall of the first litter box may be at least partially concave, and a top edge of the front wall of the second litter box may be at least partially concave.

One or more surfaces of the first litter box and one or more surfaces of the second litter box may have a fluid-resistant coating.

One or more surfaces of the first litter box and one or more surfaces of the second litter box may have an odor-absorbing coating. The odor-absorbing coating may comprise carbon filter paper or zeolite crystals or powder.

The system may further comprise a prepackaged amount of cat litter. The first and second litter boxes may be configured to be nested to define an enclosed chamber to hold the prepackaged amount of cat litter for shipping.

An end of the first litter box formed by the rear wall of the first litter box may be configured to be nestable partially within and perpendicular to the second litter box.

The system may further comprise a privacy hood comprising opposing front and rear walls, opposing side walls, and a top wall integral with the front, rear, and side walls to define a hood chamber having an open bottom end. An access hole is defined in the front wall of the privacy hood to enable access to the hood chamber. The privacy hood is sized to nest on top of the first litter box and/or the second litter box.

In alternative embodiments of the invention, a disposable litter box comprises opposing front and rear walls, opposing side walls, and a floor that is integral with the front, rear, and side walls to define a first chamber having an open top end. The litter box is constructed from a single unitary piece of cardboard such that there are no seams between the front wall and each side wall and there are no seams between the rear wall and each side wall.

The rear wall may be taller than the front wall such that the side walls slope downward from the rear wall to the front wall.

A top edge of the front wall may be at least partially concave.

One or more surfaces of the litter box may have a fluid-resistant coating.

One or more surfaces of the litter box may have an odor-absorbing coating. The odor-absorbing coating may comprise carbon filter paper or zeolite crystals or powder.

In alternative embodiments of the invention, a method of packaging a litter system for shipping comprises constructing a first litter box, constructing a second litter box, placing a prepackaged amount of cat litter into a first chamber of the first litter box, and placing the second litter box over the first litter box in a nested arrangement such that the cat litter is fully enclosed within the first and second litter boxes. The first litter box comprises opposing front and rear walls, opposing side walls, and a floor that is integral with the front, rear, and side walls to define the first chamber having an open top end. The first litter box is constructed from a single unitary piece of cardboard such that there are no seams between the front wall and each side wall of the first litter box and there are no seams between the rear wall and each side wall of the first litter box. The second litter box comprises opposing front and rear walls, opposing side walls, and a floor integral with the front, rear, and side walls to define a second chamber having an open top end. The second litter box is constructed from a single unitary piece of cardboard such that there are no seams between the front wall and each side wall of the second litter box and there are no seams between the rear wall and each side wall of the second litter box. The second litter box is sized such that the first litter box is nestable within the second litter box.

The method may further comprise securing the first and second litter boxes in the nested arrangement. The method may further comprise placing the nested first and second litter boxes into a shipping box.

The method may further comprise constructing a third litter box and placing the nested first and second litter boxes into the third litter box in a nested arrangement. The third litter box comprises opposing front and rear walls, opposing side walls, and a floor integral with the front, rear, and side walls to define a third chamber having an open top end. The third litter box is constructed from a single unitary piece of cardboard such that there are no seams between the front wall and each side wall of the third litter box and there are no seams between the rear wall and each side wall of the third litter box. The third litter box is sized such that the second litter box is nestable within the third litter box.

The method may further comprise constructing a fourth litter box and placing the fourth litter box over the nested first, second, and third litter boxes in a nested arrangement. The fourth litter box comprises opposing front and rear walls, opposing side walls, and a floor integral with the front, rear, and side walls to define a fourth chamber having an open top end. The fourth litter box is constructed from a single unitary piece of cardboard such that there are no seams between the front wall and each side wall of the fourth litter box and there are no seams between the rear wall and each side wall of the fourth litter box. The fourth litter box is sized such that the third litter box is nestable within the fourth litter box.

In alternative embodiments of the invention, a blank of foldable sheet material comprises a bottom panel having opposing front and rear edges and opposing left and right side edges; a proximal rear panel extending from the rear edge of the bottom panel; a distal rear panel extending from a distal edge of the proximal rear panel; a proximal front panel extending from the front edge of the bottom panel; a distal front panel extending from a distal edge of the proximal front panel; a proximal left side panel extending from the left side edge of the bottom panel; a distal left side panel extending from a distal edge of the proximal left side panel; a proximal right side panel extending from the right side edge of the bottom panel; a distal right side panel extending from a distal edge of the proximal right side panel; a left rear corner panel extending from both a left edge of the proximal rear panel and a rear edge of the proximal left side panel, the left rear corner panel being foldable along a diagonal line extending from an intersection of the left edge of the proximal rear panel and the rear edge of the proximal left side panel; a right rear corner panel extending from both a right edge of the proximal rear panel and a rear edge of the proximal right side panel, the right rear corner panel being foldable along a diagonal line extending from an intersection of the right edge of the proximal rear panel and the rear edge of the proximal right side panel; a left front corner panel extending from both a left edge of the proximal front panel and a front edge of the proximal left side panel, the left front corner panel being foldable along a diagonal line extending from an intersection of the left edge of the proximal front panel and the front edge of the proximal left side panel; and a right front corner panel extending from both a right edge of the proximal front panel and a front edge of the proximal right side panel, the right front corner panel being foldable along a diagonal line extending from an intersection of the right edge of the proximal front panel and the front edge of the proximal right side panel. The left rear corner panel is configured to fold upward and inward as the proximal rear panel and the proximal left side panel are folded upward in relation to the bottom panel. The right rear corner panel is configured to fold upward and inward as the proximal rear panel and the proximal right side panel are folded upward in relation to the bottom panel. The left front corner panel is configured to fold upward and inward as the proximal front panel and the proximal left side panel are folded upward in relation to the bottom panel. The right front corner panel is configured to fold upward and inward as the proximal front panel and the proximal right side panel are folded upward in relation to the bottom panel. The distal rear panel is configured to fold over against the proximal rear panel. The distal front panel is configured to fold over against the proximal front panel. The distal left side panel is configured to fold over against the proximal left side panel. The distal right side panel is configured to fold over against the proximal right side panel. Either the distal rear panel or the distal left side panel are configured to fold over the left rear corner panel when the left rear corner panel is folded upward and inward. Either the distal rear panel or the distal right side panel are configured to fold over the right rear corner panel when the right rear corner panel is folded upward and inward. Either the distal front panel or the distal left side panel are configured to fold over the left front corner panel when the left front corner panel is folded upward and inward. Either the distal front panel or the distal right side panel are configured to fold over the right front corner panel when the right front corner panel is folded upward and inward.

The distal edge of the proximal left side panel may be at an angle from the left side edge of the bottom panel. The distal edge of the distal left side panel may be at an angle from the left side edge of the bottom panel. The distal edge of the proximal right side panel may be at an angle from the right side edge of the bottom panel. The distal edge of the distal right side panel may be at an angle from the right side edge of the bottom panel.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view of a cat litter box, in accordance with embodiments of the present invention.

FIG. 2 is a bottom perspective view of the litter box of FIG. 1.

FIG. 3 is a front view of the litter box of FIG. 1.

FIG. 4 is a rear view of the litter box of FIG. 1.

FIG. 5 is a right side view of the litter box of FIG. 1.

FIG. 6 is a left side view of the litter box of FIG. 1.

FIG. 7 is a top view of the litter box of FIG. 1.

FIG. 8 is a bottom view of the litter box of FIG. 1.

FIGS. 9 and 10 are perspective views illustrating the nesting ability of two cat litter boxes, in accordance with embodiments of the present invention.

FIG. 11 is a perspective view illustrating the nesting ability of four cat litter boxes, in accordance with embodiments of the present invention.

FIG. 12 is a perspective view of two cat litter boxes arranged in a box/shield configuration, in accordance with embodiments of the present invention.

FIG. 13 is a die line for constructing a cat litter box, in accordance with embodiments of the present invention.

FIG. 14 illustrates the assembly of a cat litter box, in accordance with embodiments of the present invention.

FIGS. 15 and 16 are perspective views illustrating the nesting ability of a cat litter box and a privacy hood, in accordance with embodiments of the present invention.

### DETAILED DESCRIPTION OF THE DISCLOSURE

Certain terminology is used in the following description for convenience only and is not limiting. The words “lower,” “bottom,” “upper,” “top,” and the like designate directions in the drawings to which reference is made. The words “inwardly,” “outwardly,” “upwardly,” “downwardly,” and the like refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

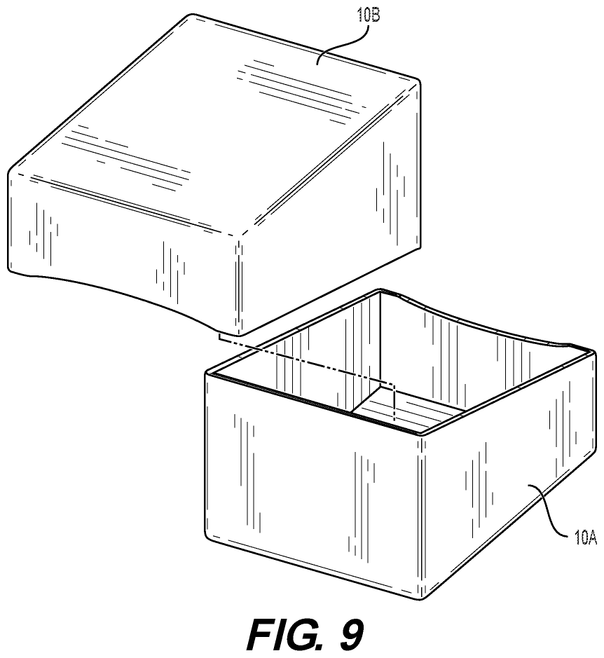

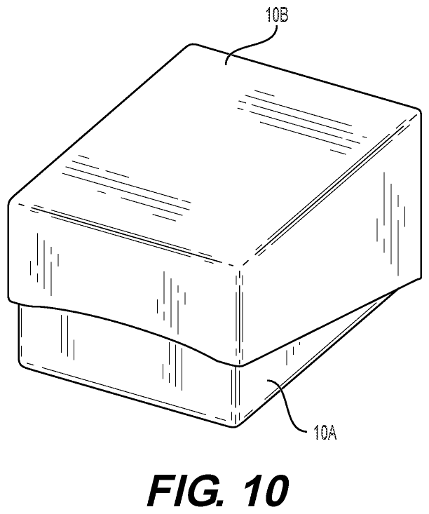

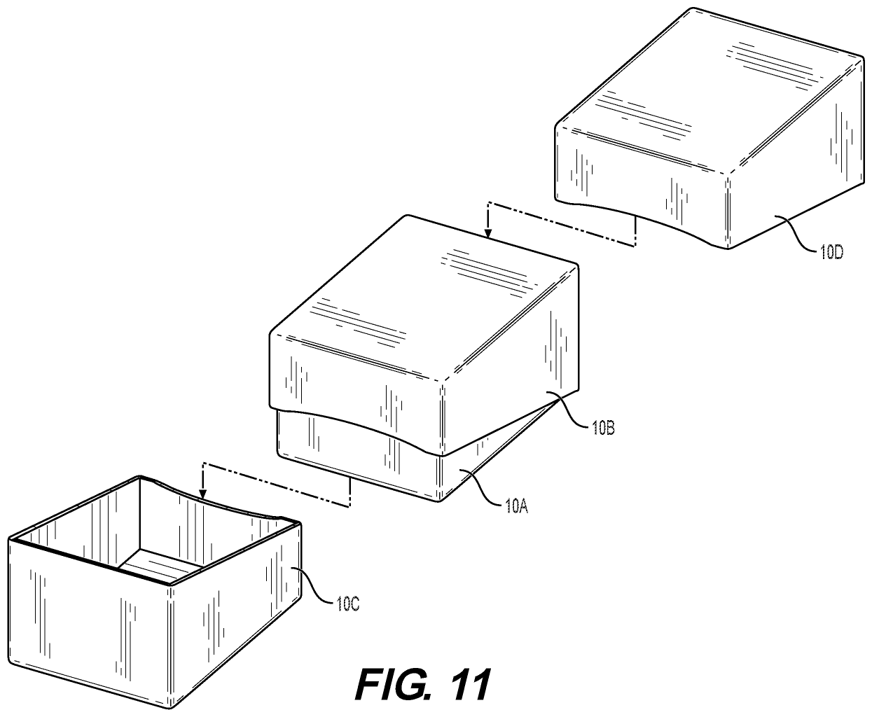

The double use disposable litter system of embodiments of the invention comprises two disposable and recyclable litter boxes uniquely designed from two pieces of corrugated fiberboard carton—commonly referred to as “corrugated cardboard” or simply “cardboard”—which are the same shape as each other, with one slightly larger than the other. This is a modified version of a “telescope style” box commonly described within the packaging industry as consisting of top and bottom pieces that fit over each other, as seen in FIGS. 9 and 10. The system may further comprise up to two additional disposable and recyclable litter boxes, referred to as shells, which further encase the primary two-piece unit. One shell is slightly larger than the larger of the two primary boxes, while the other shell is slightly larger than the other shell. As such, all four boxes can fit together in a nested arrangement as seen in FIG. 11.

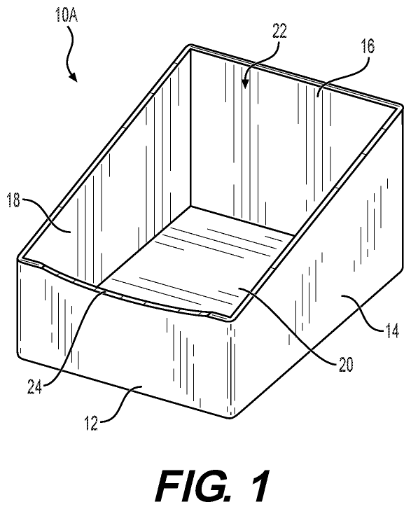

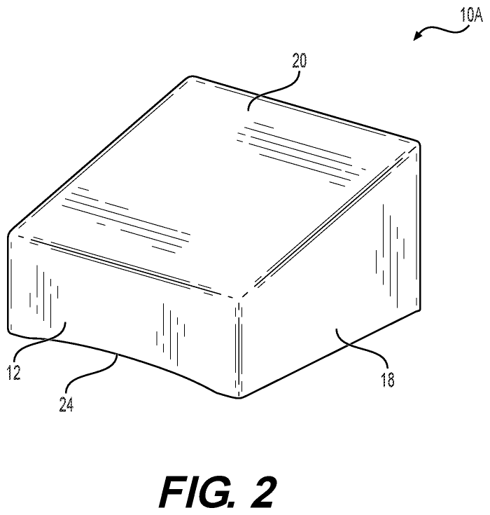

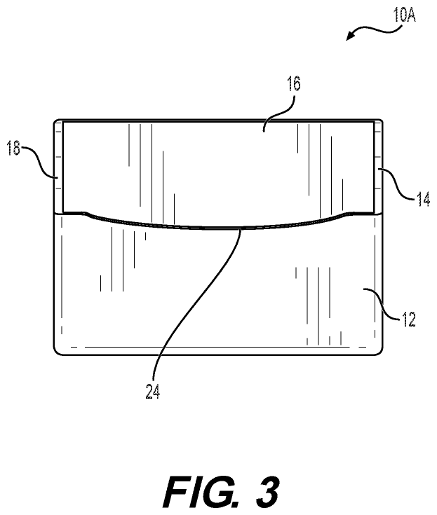

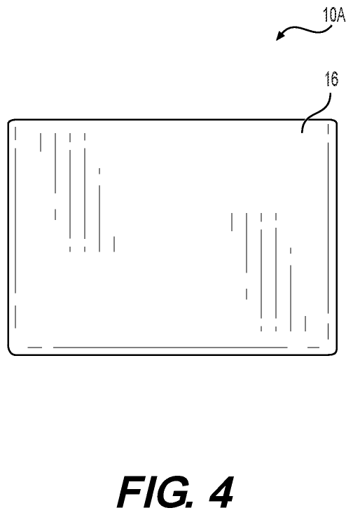

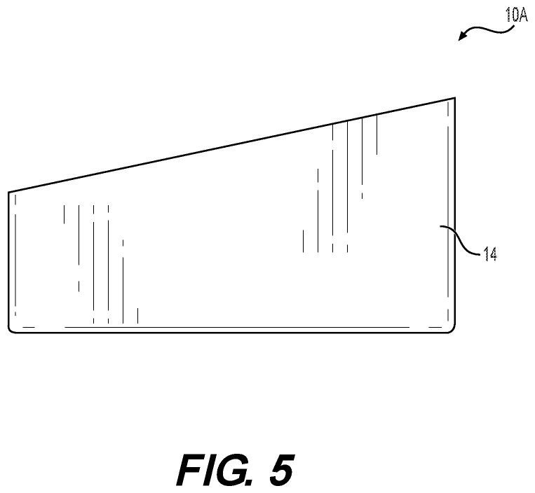

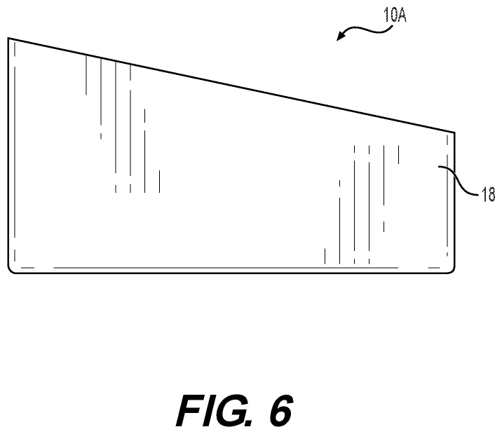

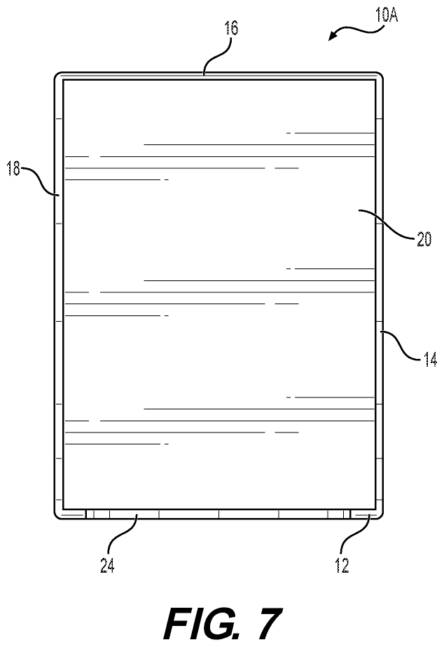

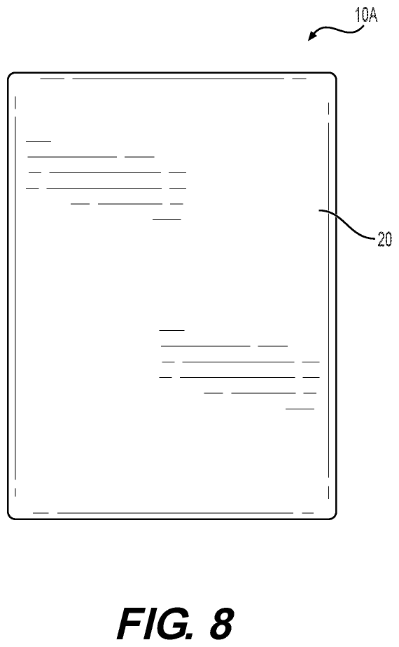

FIGS. 1-8 illustrate one box of the double use disposable litter system of embodiments of the invention. For simplicity, the seams and folds of the boxes are not illustrated in FIGS. 1-14. As seen in FIGS. 1-8, a first box 10A has a generally rectangular prism shape, with a front wall 12, a right side wall 14, a rear wall 16, a left side wall 18, and a bottom 20 defining a chamber 22. The first box 10A has an open top end. Notably, the side walls 14, 18 slope downward from the rear wall 16 to the front wall 12. The top edge of the front wall 12 has a concavity 24 that provides for easier entry into the box.

FIGS. 9 and 10 illustrate the first box 10A and a second box 10B. The first box 10A and the second box 10B are identical, except that the second box 10B is slightly larger than the first box 10A. This allows the two boxes to nest as shown, with the first box 10A partially nested inside the larger box 10B. The boxes are preferably nested with the front wall of the first box being adjacent the rear wall of the second box and the rear wall of the first box being adjacent the front wall of the second box. FIG. 11 illustrate the nesting of the first box 10A, the second box 10B, a third box 10C, and a fourth box 10D (the third and fourth boxes may also be referred to as shells).

The interior of each piece has preferably been sealed against urine penetration with a water resistant coating. As a final line of defense against urine penetration, and for more shipping durability, the cardboard material is preferably much thicker than standard cardboard boxes, in one exemplary embodiment using a 200 # Test Board and the Flute is B. The board may be Kraft (brown) in color inside and outside of the box. Alternatively, white cardboard may be used, and the interior walls printed with a solid tan color to reduce the visual of any liquids or waste that may end up on the interior walls. The liner combination will be, in one exemplary embodiment, 42 # Liner—23 # Medium (Flute) —42 # Liner. These pieces, assembled—whether it be two, three, or four pieces—form a standard-shaped shipping parcel (i.e., a rectangular prism) when nested as indicated in FIG. 11. Separated, each piece may function independently as a litter box, which allows for an extension or “doubling” of the life of the system. This creates multiple usage opportunities: In one example, for one-cat households, the user gets two months of use per shipped unit instead of one, and up to four months of use if both optional shell pieces are added. In a second example, for two-cat households, the customer need only order one unit for one month of use, or one unit with both optional shell pieces for two months of use. This function benefits all multi-cat households, reducing the units needed by half regardless of the cat count. The standard industry recommendation is one litter box per cat, so existing litter and box subscription services seem to have built their offerings around a shipment recurring monthly. The Double Use Disposable Litter System of embodiments of the invention satisfies the litter needs of one cat for up to four months, or two cats for up to two months.

The nested pieces of each unit are preferably secured together for shipment using polypropylene strapping or other strapping materials. This makes for easier deployment by the user compared to taping, stapling, or other solutions. Alternatively, one may forgo the strapping and place the unsecured nested pieces inside a standard shipping box. Advantageously, a desired amount of packaged cat litter (typically packaged in one or more bags, with each individual bag containing an amount of litter for use in one litter box for one month) is placed in the innermost of the nested litter boxes for shipping, along with any other supplies that may be ordered by the user.

Other disposable litter box systems involve multistep setup of the box; unfolding of panels, attachment of extension panels to side walls, installation of support strips, and the separate setup and installation of a privacy hood to name a few. The system of embodiments of the invention has no such installation steps or requirements. The pieces, which may have doubled as the shipping parcel, are simply separated and positioned according to the specific needs of the user. The sidewalls for privacy and retention of pawed litter are stationary and already in place. The assembly of the pieces into box form is typically completed by an order fulfillment company before shipment to the user.

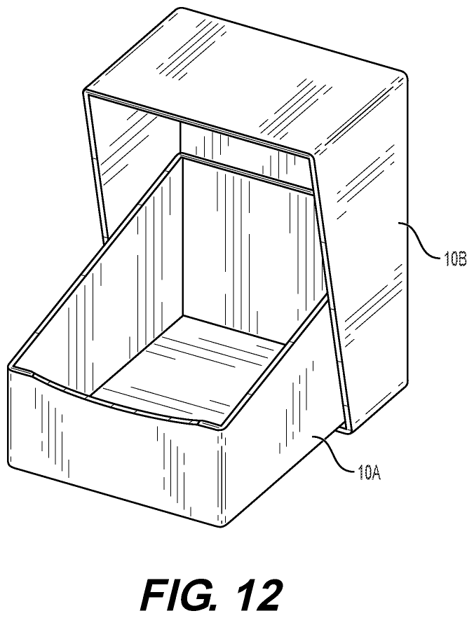

The primary two-piece unit, once separated, may be deployed for use in four different ways: First, as two separate and active litter boxes. Second, with the smaller piece nested in the same orientation inside the larger piece in such a way that the thickness of all panels and the bottom is doubled. Third, with the smaller piece placed inside the larger piece in such a way that the larger piece creates a higher back wall, higher sides in the rear of the box, and a shallow privacy hood, similar to FIG. 12 but with the narrower end of box 10B at the top. Fourth, with the smaller piece (10A) placed inside the larger piece (10B) in such a way that the larger piece creates a higher back wall, higher sides in the rear of the box, and a deep privacy hood, as seen in FIG. 12. Adding one or two shell pieces to the unit simply duplicates these choices and results in longer usage of the unit.

Even without the deployment of the system in one of the combined methods previously stated, the shape of each individual litter box piece creates a high back and high sloping side walls for the “comfort of closeness” and privacy desired by cats, and the prevention of tracking and tossing of litter through cat movement, pawing, and scratching, while the front entrance is low for easy access for cats of all ages. The pairing of the individual pieces together only enhances these features further, and, if nothing else, eliminates the need for additional storage space for the second piece when not deployed for active use.

Given the increasing sizes of each shell, the end-user may optionally select the sizes most appropriate for their given situation. For example, the largest two shells may be preferable for large cats. Such a selection, given the system design, adds no complications for shipping.

In one embodiment (not illustrated), the top edges of the lowered, curved entry point 24 on each piece are taped over in such a way that the medium—which is the wavy, fluted paper between the liners—is not exposed. The medium becomes exposed during the manufacturing and cutting process, and could become a hazard to cats should a claw become entangled in the openings created by the flutes.

In one embodiment, the interior surfaces of each piece are coated with water-based HydraBan®, Coating X300™, or Michem® Coat 40 Plus, all manufactured by Michelman, Inc. Other suitable coatings could be used.

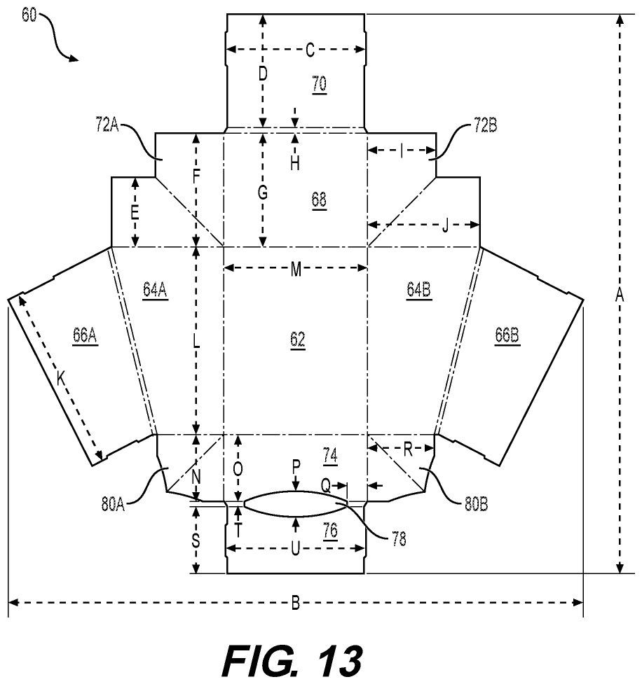

In one embodiment, each litter box of the system is formed from a single, continuous sheet of cardboard, typically termed a blank. When cut and then folded/assembled according to this method, no seams or openings from the interior of the litter box are open to the outside of the box. In other words, even though there are visual seams and corners that appear in the interior, they are all superficial and are all covered/capped by another layer of cardboard from the folding method. This structure is yet another defense against liquids reaching the exterior of the system. The general template (also termed a die line) for cutting each litter box (in accordance with one embodiment of the invention) is illustrated in FIG. 13, although most of the dimensions (labeled as letters in FIG. 13) vary according to the desired size of the litter box. (The die line is used to create a die, which is used to stamp blanks in the desired shape. The die line defines the perimeter of the blank, fold lines (indicated by dot-dash lines in FIG. 13), perforations, etc.) For one specific example of the system, Table 1 below shows the dimensions (in inches) for each of four different size litter boxes.

TABLE 1

| Dimension | Box A | Box B | Box C | Box D |
|---|---|---|---|---|
| A | 49 13/16 | 51 1/16 | 49 9/16 | 50 13/16 |
| B | 51¼ | 52⅙ | 53 | 53⅚ |
| C | 12½ | 13⅛ | 13¾ | 14⅜ |
| D | 10 1/16 | 10 1/16 | 7 5/16 | 7 5/16 |
| E | 6 3/16 | 6 3/16 | 6 15/16 | 7¼ |
| F | 10 1/16 | 10 1/16 | 10 1/16 | 10 1/16 |
| G | 10⅛ | 10⅛ | 10⅛ | 10⅛ |
| H | ⅜ | ⅜ | ⅜ | ⅜ |
| I | 6 3/16 | 6 3/16 | 6 15/16 | 7¼ |
| J | 10 1/16 | 10 1/16 | 10 1/16 | 10 1/16 |
| K | 16 9/16 | 17 13/16 | 19 1/16 | 20 5/16 |
| L | 16 11/16 | 17 15/16 | 19 3/16 | 20 7/16 |
| M | 12⅝ | 13¼ | 13⅞ | 14½ |
| N | 6 1/16 | 6 1/16 | 6 1/16 | 6 1/16 |
| O | 6⅛ | 6⅛ | 6⅛ | 6⅛ |
| P | 2 | 2 | 2 | 2 |
| Q | 1½ | 1 23/32 | 1 23/32 | 1 23/32 |
| R | 6 1/16 | 6 1/16 | 6 1/16 | 6 1/16 |
| S | 6 1/16 | 6 1/16 | 6 1/16 | 6 1/16 |
| T | ⅜ | ⅜ | ⅜ | ⅜ |
| U | 12½ | 13⅛ | 13¾ | 14⅜ |

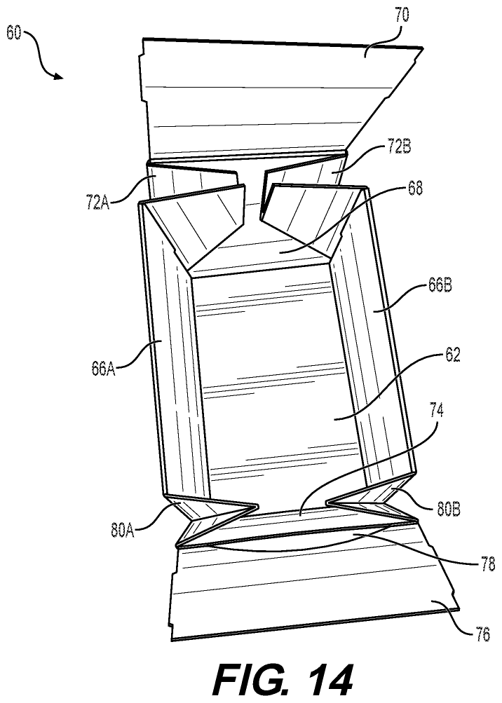

As seen in FIG. 13, the template or die line defines the single unitary sheet 60 of cardboard that is folded to create a litter box without any seams that could allow fluid or waste to leak out of the box. The sheet 60 comprises a bottom panel 62 that forms the bottom surface, a left proximal side panel 64A and a left distal side panel 66A that together form the left side wall, a right proximal side panel 64B and a right distal side panel 66B that together form the right side wall, a rear proximal panel 68 and a rear distal panel 70 that together form the rear wall, a left rear corner panel 72A that forms the seamless corner between the left side wall and the rear wall, a right rear corner panel 72B that forms the seamless corner between the right side wall and the rear wall, a front proximal panel 74 and a front distal panel 76 that together form the front wall, a generally oval cutout 78 at the seam between the front proximal panel 74 and the front distal panel 76 to define the concavity at the top edge of the front wall, a left front corner panel 80A that forms the seamless corner between the left side wall and the front wall, and a right front corner panel 80B that forms the seamless corner between the right side wall and the front wall. The dot-dash lines in FIG. 13 illustrate fold lines, typically formed by pressing a crease in the cardboard sheet. FIG. 14 illustrates the cardboard sheet or blank 60 in the process of being folded into a litter box, in which the function of the corner panels is readily apparent. To complete the assembly, the rear distal panel 70 is folded over and seated against the left rear corner panel 72A and the right rear corner panel 72B, and the front distal panel 76 is folded over and seated against the left front corner panel 80A and the right front corner panel 80B.

In one embodiment, an odor-removing media is attached to the interior surfaces of each piece above the litter fill line with a heat-activated adhesive coating. This media may be a composite film of cellulose nanofibrils (CNF) with a high content of nanoporous zeolite adsorbents that have been colloidally processed. Or, the media may be commercially available activated carbon paper. Each has a different pore structure and a different level of effectiveness for urine and fecal odors. Zeolites and activated carbons, in granular and powdered form, have previously been integrated into litter substrates themselves; however, integration of these materials into a box is a new approach to litter odor control and a new innovation. Rising odors are absorbed by the upper interiors of the box at the point where the exposed surfaces above the litter fill line have been faced with the media. In one specific embodiment, carbon filter paper manufactured by Onyx Specialty Papers, Inc. may be adhered to one or more inside walls of the litter box. This carbon filter paper does not come with an adhesive surface, so after assembly of the box unit, an aerosolized adhesive (such as STA′-PUT SP4H manufactured by ITW Polymers Sealants North America) would be lightly sprayed on the inside of the box, and then pre-cut sheets of the carbon filter paper—matching each side—would be put into place before the adhesive dries. In another specific embodiment, 14×40 Mesh Zeolite from a deposit called Sheaville located along the Idaho and Oregon border mined by Ida-Ore Mining, LLC may be adhered to one or more inside walls of the litter box using an aerosolized adhesive (such as STA′-PUT® SP4H). The adhesive would be sprayed on the interior wall(s), followed by a spraying of the nearly-powder zeolite. The box is then passed under a heat lamp for fast drying prior to “nesting” of the boxes and final packaging.

In a more simple embodiment, the interior surfaces of each piece above the litter fill line are treated with a heat-activated adhesive coating and then a powder coating of either micronized zeolite or activated carbon is applied to achieve the same general effect.

The Double Use Disposable Litter System is appropriate for various types of litters. For use with silica gel litters, an absorbent pad or pouch may optionally be added. Silica gel, which is made of sodium silicate sand and is processed into either bead or granular silica gel, attracts and holds water by adsorption and capillary condensation, rather than absorption. Once adsorbed, moisture evaporates from the gel granules through frequent stirring so the same material may be used repeatedly. This is much different from most clumping litters which absorb and retain urine for later removal and disposal. Pet owners, who otherwise appreciate the functionality of silica gel litters, may be perturbed by the concept of urine moisture evaporation into the home environment's air.

In an optional embodiment, the interior surface of the rear wall piece above the litter fill line may be faced with a pad or thin mesh pouch containing a hygroscopic material such as rock salt, Calcium chloride, or sodium hydroxide (lye) for quick and ongoing moisture absorption. The system user need not interact with or maintain this optional feature in any way, and it is simply disposed of along with the entire unit at the end of the use period.

The litter box system of embodiments of the invention may also comprise a disposable cat litter box anti-tracking privacy hood that is constructed from a single, custom-cut piece of corrugated fiberboard carton—commonly referred to as “corrugated cardboard” or simply “cardboard” of either light brown or white color. This material is chosen so the hood may be recycled or disposed of after a short period of time, unlike other hood products. The hood is designed to both ship in a collapsed, nearly flat state and also assemble easily, taking the general shape of a rectangular box, for quick deployment by the end user. The cardboard folds and interlocks in such a way that the top of the assembled hood does not allow any visibility through to the litter pan underneath or allow a cat litter substrate to pass up through it when disturbed by cat activity. The bottom of the hood, once assembled, is entirely open. The left, right, and rear panels of the assembled hood are entirely solid with no interlocking folds—all connection points of the cardboard have been consolidated to the top of the hood, so that the rear and side panels, which are most likely to encounter thrown or pawed litter, have no possibility of penetration by litter substrates. The front panel of the hood contains a downward sloped access hole for the cat to use when entering and exiting the litter box. It is sized to be both comfortably wide enough for cat access but also no wider than necessary to reduce the risk of frontward litter substrate disturbance. With the same intention, the bottom of the access hole is sloped and aligned with the matching litter shell described above.

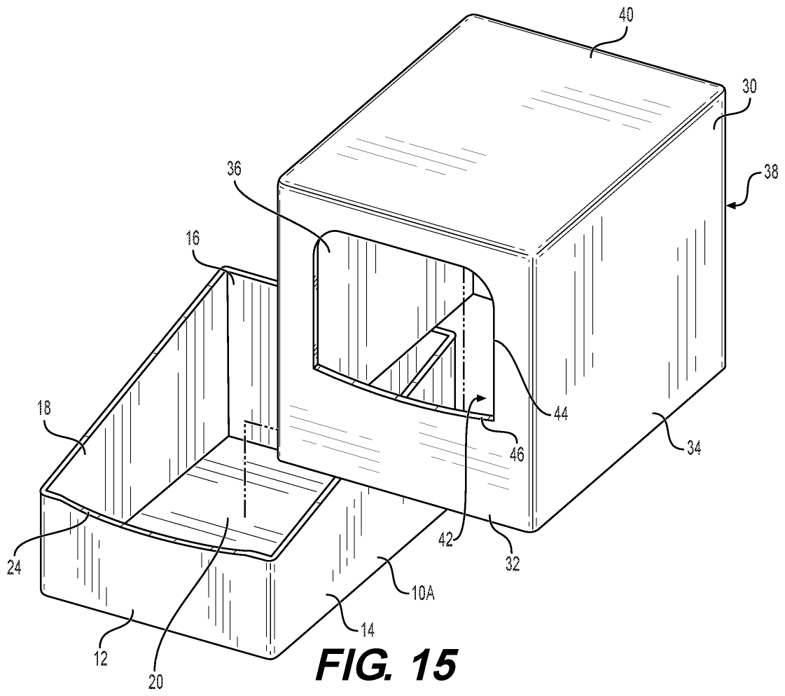

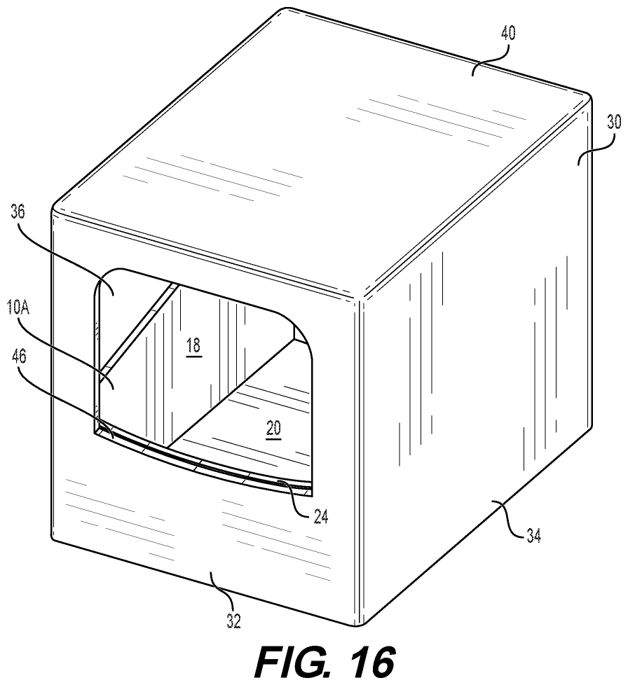

Referring now to FIGS. 15 and 16, a privacy hood 30 is illustrated. The privacy hood 30 comprises a front wall 32, right side wall 34, left side wall 36, rear wall 38, and top wall 40, all defining a chamber 42. The front wall 32 defines an opening 44 to enable a cat to enter the enclosed space defined by the privacy hood 30 and litter box 10A when nested as shown in FIG. 16. The concavity 46 of the bottom edge of the privacy hood 30 matches and aligns with the concavity 24 of the front wall of the litter box 10A.

The hood is sized to slide easily but tightly over the Double Use Disposable Litter System shells. The integrated fit must be tight, so disturbed litter substrate does not fall between the walls of the shell and the walls of the hood, but also loose enough so that the end user does not struggle to integrate the hood and the system shell as the hood is removed frequently during deployment for removal of litter substrate clumps or to stir non-clumping litter substrates. The actual sizing of the hood can vary widely but corresponds to the shell sizes of the Double Use Disposable Litter System when the two are to be used together.

In one embodiment, the interior surfaces of the hood may be sealed against urine penetration with a water-resistant coating, such as water-based HydraBan®, Coating X300™, or Michem® Coat 40 Plus, all manufactured by Michelman, Inc. Though when integrated with the Double Use Disposable Litter System this is redundant and likely not necessary. Such a coating is suggested when integrated with other litter boxes that lack coated sidewalls.

In one embodiment, an odor-removing media is attached to the interior surfaces of the hood with a heat-activated adhesive coating, in a similar manner as is described above in relation to the interior surfaces of the litter box. Zeolites and activated carbons, in granular and powdered form, have previously been integrated into litter substrates themselves; however, integration of these materials into a litter box hood is a new approach to litter odor control and a new innovation. Rising odors are absorbed by the new “ceiling” of the integrated system.

In a more simple embodiment, the interior surfaces of the hood are treated with a heat-activated adhesive coating and then a powder coating of either micronized zeolite or activated carbon is applied to achieve the same general effect. Yet another option is to spray the interior of each piece with an odor-controlling deodorizer, biocide, or fragrance, such as Acticide® MBS, a biocide manufactured by Thor Specialties, Inc. or DeodEclyx™ FRESH DAYS MOC 469932, a fragrance and anti-odor technology manufactured by Firmenich SA. The heat lamp protocol described above would apply to this, too.

The Disposable Cat Litter Box Anti-Tracking Privacy Hood addresses five problems at once. First, the expulsion and further tracking of litter substrate outside the litter box: The activities of a cat in a litter box—either from intended use, play, or simply entering and exiting the box—lead to pawing and other disturbance of the litter substrate that can leave large amounts of the litter outside the contained area, contributing to issues of human cleanliness and discomfort. The hood disclosed here significantly reduces the scenarios in which the litter substrate may be displaced from the contained area. Second, the free release of malodors: Enclosing a litter box or pan on all sides, with the exception of a small access point, reduces the free emission of urine and fecal odors into the indoor air environment when urine clumps and feces are otherwise directly exposed, uncovered, and open to the room housing the litter box. Third, the visual unpleasantness of an in-use litter box or pan's contents: Often, litter boxes must be kept in rooms of homes also frequented by humans. In small dwellings, such as apartments, it is common for litter boxes to be deployed for use in bathrooms. The contents of a litter box in-use—urine clumps and feces—are obviously unsightly and unpleasant to see or be near for human residents and guests. The Privacy Hood significantly reduces the visibility of the litter box contents and reduces the overall noticeable presence of a litter box system. Fourth, the known fussiness and private habits of cats: Cats easily find fault with the litter box systems provided to them. When this occurs, cats then find alternative areas of the home—where they feel more secure and comfortable—to carry out metabolic excretions. A key point of rejection in regard to litter boxes and pans is a lack of privacy or the lack of a sense of security. A five-sided hood with only a small access point eliminates this issue, even when it is not possible to deploy the litter box in a quiet or private area of a home. Fifth, the accrual of debris and odor causing wetness on traditional plastic hoods: Cats behave unpredictably in their urination and other metabolic functions. It is not uncommon to find waste on unexpected surfaces of a box and hood system. Traditional hoods are made of plastic, decorative wood, or other non-disposable materials. As such they must we cleaned and scrubbed frequently to maintain cleanliness and odor control—yet another unpleasant duty of cat owners. The Disposable Cat Litter Box Anti-Tracking Privacy Hood is intentionally made from a material that is of little cost and can therefore be replaced regularly and before the need for washing and cleaning arises.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below (if any) are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A disposable litter system comprising:
a first litter box comprising opposing front and rear walls, opposing side walls, and a floor that is integral with the front, rear, and side walls to define a first chamber having an open top end;
a second litter box comprising opposing front and rear walls, opposing side walls, and a floor integral with the front, rear, and side walls to define a second chamber having an open top end;
wherein the first litter box is constructed from a single unitary piece of cardboard such that there are no seams between the front wall and each side wall of the first litter box and there are no seams between the rear wall and each side wall of the first litter box;
wherein the second litter box is constructed from a single unitary piece of cardboard such that there are no seams between the front wall and each side wall of the second litter box and there are no seams between the rear wall and each side wall of the second litter box; and
wherein the second litter box is sized such that the first litter box is nestable within the second litter box.

2. The system of claim 1, further comprising:
a third litter box constructed from a single unitary piece of cardboard, the third litter box comprising opposing front and rear walls, opposing side walls, and a floor integral with the front, rear, and side walls to define a third chamber having an open top end;
wherein the third litter box is sized such that the second litter box is nestable within the third litter box.

3. The system of claim 2, further comprising:
a fourth litter box constructed from a single unitary piece of cardboard, the fourth litter box comprising opposing front and rear walls, opposing side walls, and a floor integral with the front, rear, and side walls to define a fourth chamber having an open top end;
wherein the fourth litter box is sized such that the third litter box is nestable within the fourth litter box.

4. The system of claim 1, wherein the rear wall of the first litter box is taller than the front wall of the first litter box such that the side walls of the first litter box slope downward from the rear wall of the first litter box to the front wall of the first litter box; and
wherein the rear wall of the second litter box is taller than the front wall of the second litter box such that the side walls of the second litter box slope downward from the rear wall of the second litter box to the front wall of the second litter box.

5. The system of claim 1, wherein a top edge of the front wall of the first litter box is at least partially concave; and
wherein a top edge of the front wall of the second litter box is at least partially concave.

6. The system of claim 1, wherein one or more surfaces of the first litter box and one or more surfaces of the second litter box have a fluid-resistant coating.

7. The system of claim 1, wherein one or more surfaces of the first litter box and one or more surfaces of the second litter box have an odor-absorbing coating.

8. The system of claim 7, wherein the odor-absorbing coating comprises carbon filter paper or zeolite crystals or powder.

9. The system of claim 1, further comprising a prepackaged amount of cat litter; and
wherein the first and second litter boxes configured to be nested to define an enclosed chamber to hold the prepackaged amount of cat litter for shipping.

10. The system of claim 1, wherein an end of the first litter box formed by the rear wall of the first litter box is configured to be nestable partially within and perpendicular to the second litter box.

11. The system of claim 1, further comprising:
a privacy hood comprising opposing front and rear walls, opposing side walls, and a top wall integral with the front, rear, and side walls to define a hood chamber having an open bottom end;
wherein an access hole is defined in the front wall of the privacy hood to enable access to the hood chamber; and
wherein the privacy hood is sized to nest on top of the first litter box and/or the second litter box.

12. A disposable litter box comprising
opposing front and rear walls;
opposing side walls; and
a floor that is integral with the front, rear, and side walls to define a first chamber having an open top end;
wherein the litter box is constructed from a single unitary piece of cardboard such that there are no seams between the front wall and each side wall and there are no seams between the rear wall and each side wall.

13. The disposable litter box of claim 12, wherein the rear wall is taller than the front wall such that the side walls slope downward from the rear wall to the front wall.

14. The disposable litter box of claim 12, wherein a top edge of the front wall is at least partially concave.

15. The disposable litter box of claim 12, wherein one or more surfaces of the litter box have a fluid-resistant coating.

16. The disposable litter box of claim 12, wherein one or more surfaces of the litter box have an odor-absorbing coating.

17. The disposable litter box of claim 16, wherein the odor-absorbing coating comprises carbon filter paper or zeolite crystals or powder.

18. A method of packaging a litter system for shipping, the method comprising:
constructing a first litter box comprising opposing front and rear walls, opposing side walls, and a floor that is integral with the front, rear, and side walls to define a first chamber having an open top end, wherein the first litter box is constructed from a single unitary piece of cardboard such that there are no seams between the front wall and each side wall of the first litter box and there are no seams between the rear wall and each side wall of the first litter box;
constructing a second litter box comprising opposing front and rear walls, opposing side walls, and a floor integral with the front, rear, and side walls to define a second chamber having an open top end, wherein the second litter box is constructed from a single unitary piece of cardboard such that there are no seams between the front wall and each side wall of the second litter box and there are no seams between the rear wall and each side wall of the second litter box, and wherein the second litter box is sized such that the first litter box is nestable within the second litter box;
placing a prepackaged amount of cat litter into the first chamber; and
placing the second litter box over the first litter box in a nested arrangement such that the cat litter is fully enclosed within the first and second litter boxes.

19. The method of claim 18, further comprising:
securing the first and second litter boxes in the nested arrangement.

20. The method of claim 18, further comprising:
placing the nested first and second litter boxes into a shipping box.

21. The method of claim 18, further comprising:
constructing a third litter box comprising opposing front and rear walls, opposing side walls, and a floor integral with the front, rear, and side walls to define a third chamber having an open top end, wherein the third litter box is constructed from a single unitary piece of cardboard such that there are no seams between the front wall and each side wall of the third litter box and there are no seams between the rear wall and each side wall of the third litter box, and wherein the third litter box is sized such that the second litter box is nestable within the third litter box; and
placing the nested first and second litter boxes into the third litter box in a nested arrangement.

22. The method of claim 21, further comprising:
constructing a fourth litter box comprising opposing front and rear walls, opposing side walls, and a floor integral with the front, rear, and side walls to define a fourth chamber having an open top end, wherein the fourth litter box is constructed from a single unitary piece of cardboard such that there are no seams between the front wall and each side wall of the fourth litter box and there are no seams between the rear wall and each side wall of the fourth litter box, and wherein the fourth litter box is sized such that the third litter box is nestable within the fourth litter box; and
placing the fourth litter box over the nested first, second, and third litter boxes in a nested arrangement.

23. The method of claim 18, wherein the rear wall of the first litter box is taller than the front wall of the first litter box such that the side walls of the first litter box slope downward from the rear wall of the first litter box to the front wall of the first litter box;
wherein the rear wall of the second litter box is taller than the front wall of the second litter box such that the side walls of the second litter box slope downward from the rear wall of the second litter box to the front wall of the second litter box; and
wherein the second litter box is placed over the first litter box in a nested arrangement with the front wall of the first litter box adjacent the rear wall of the second litter box and the rear wall of the first litter box adjacent the front wall of the second litter box.

24. The method of claim 18, wherein a top edge of the front wall of the first litter box is at least partially concave; and
wherein a top edge of the front wall of the second litter box is at least partially concave.

25. The method of claim 18, wherein one or more surfaces of the first litter box and one or more surfaces of the second litter box have a fluid-resistant coating.

26. The method of claim 18, wherein one or more surfaces of the first litter box and one or more surfaces of the second litter box have an odor-absorbing coating.

27. The method of claim 26, wherein the odor-absorbing coating comprises carbon filter paper or zeolite crystals or powder.

28. A blank of foldable sheet material comprising:
a bottom panel having opposing front and rear edges and opposing left and right side edges;
a proximal rear panel extending from the rear edge of the bottom panel;
a distal rear panel extending from a distal edge of the proximal rear panel;
a proximal front panel extending from the front edge of the bottom panel;
a distal front panel extending from a distal edge of the proximal front panel;
a proximal left side panel extending from the left side edge of the bottom panel;
a distal left side panel extending from a distal edge of the proximal left side panel;
a proximal right side panel extending from the right side edge of the bottom panel;
a distal right side panel extending from a distal edge of the proximal right side panel;
a left rear corner panel extending from both a left edge of the proximal rear panel and a rear edge of the proximal left side panel, the left rear corner panel being foldable along a diagonal line extending from an intersection of the left edge of the proximal rear panel and the rear edge of the proximal left side panel;
a right rear corner panel extending from both a right edge of the proximal rear panel and a rear edge of the proximal right side panel, the right rear corner panel being foldable along a diagonal line extending from an intersection of the right edge of the proximal rear panel and the rear edge of the proximal right side panel;
a left front corner panel extending from both a left edge of the proximal front panel and a front edge of the proximal left side panel, the left front corner panel being foldable along a diagonal line extending from an intersection of the left edge of the proximal front panel and the front edge of the proximal left side panel;
a right front corner panel extending from both a right edge of the proximal front panel and a front edge of the proximal right side panel, the right front corner panel being foldable along a diagonal line extending from an intersection of the right edge of the proximal front panel and the front edge of the proximal right side panel;
wherein the left rear corner panel is configured to fold upward and inward as the proximal rear panel and the proximal left side panel are folded upward in relation to the bottom panel;
wherein the right rear corner panel is configured to fold upward and inward as the proximal rear panel and the proximal right side panel are folded upward in relation to the bottom panel;
wherein the left front corner panel is configured to fold upward and inward as the proximal front panel and the proximal left side panel are folded upward in relation to the bottom panel;
wherein the right front corner panel is configured to fold upward and inward as the proximal front panel and the proximal right side panel are folded upward in relation to the bottom panel;
wherein the distal rear panel is configured to fold over against the proximal rear panel;
wherein the distal front panel is configured to fold over against the proximal front panel;
wherein the distal left side panel is configured to fold over against the proximal left side panel;
wherein the distal right side panel is configured to fold over against the proximal right side panel;
wherein either the distal rear panel or the distal left side panel are configured to fold over the left rear corner panel when the left rear corner panel is folded upward and inward;
wherein either the distal rear panel or the distal right side panel are configured to fold over the right rear corner panel when the right rear corner panel is folded upward and inward;
wherein either the distal front panel or the distal left side panel are configured to fold over the left front corner panel when the left front corner panel is folded upward and inward; and
wherein either the distal front panel or the distal right side panel are configured to fold over the right front corner panel when the right front corner panel is folded upward and inward.

29. The blank of claim 28, wherein the distal edge of the proximal left side panel is at an angle from the left side edge of the bottom panel;
wherein a distal edge of the distal left side panel is at an angle from the left side edge of the bottom panel;
wherein the distal edge of the proximal right side panel is at an angle from the right side edge of the bottom panel; and
wherein a distal edge of the distal right side panel is at an angle from the right side edge of the bottom panel.
